(19) United States
(12) Patent Application Publication
(10) Pub. No.: US 2015/0338972 A1
(43) Pub. Date: Nov. 26, 2015

(54) TOUCH PANEL AND WIRING STRUCTURE AND METHOD FOR FORMING WIRING STRUCTURE

(71) Applicant: Henghao Technology Co., Ltd., Hsinchu County (TW)

(72) Inventors: Ching-Fang Wong, Hsinchu County (TW); Chun-Ming Peng, Hsinchu County (TW)

(21) Appl. No.: 14/716,135

(22) Filed: May 19, 2015

(30) Foreign Application Priority Data
May 20, 2014 (TW) 103117697

(51) Int. Cl. G06F 3/047; G06F 3/041

(52) U.S. Cl. CPC G06F 3/047; G06F 3/0412; G06F 2203/04103

(57) ABSTRACT

A touch panel includes a substrate, a conductive sensing layer, an insulation layer and a conductive line layer. The substrate includes a central portion and a first peripheral portion. The conductive sensing layer is disposed on the central portion. The insulation layer includes a second peripheral portion, wherein the second peripheral portion has a trench structure and is disposed on the first peripheral portion. The conductive line layer is disposed in the trench structure, and is electrically connected to the conductive sensing layer. A wiring structure and a method for forming a wiring structure are also provided.

### CROSS-REFERENCE TO RELATED APPLICATION AND CLAIM OF PRIORITY

The application claims the benefit of Taiwan Patent Application No. 103117697, filed on May 20, 2014, at the Taiwan Intellectual Property Office, the disclosure of which is incorporated herein in its entirety by reference.

### TECHNICAL FIELD

The present disclosure relates to a wiring structure and, more particularly, relates to a wiring structure and a method for forming the wiring structure associated with a touch panel.

### BACKGROUND

Please refer to FIG. 1A and FIG. 1B, which are schematic diagrams respectively showing a top view and a front view of a touch panel 10 in the prior art. FIG. 1B shows a schematic front cross-sectional view at the reference line AA′ marked in FIG. 1A. The touch panel 10 includes a substrate 11, a conductive sensing layer 12, an insulation layer 13, a conductive sensing layer 14, a conductive line layer 15, a protective layer 16, an electrode layer 17 and a pad layer 18. The substrate 11 includes a central portion 111 and a peripheral portion 112 associated with the central portion 111. The conductive sensing layer 12 is disposed on the central portion 111 of the substrate 11, and has a line extension direction DR1.

The insulation layer 13 is disposed on the conductive sensing layer 12, and insulates the conductive sensing layer 12 from the conductive sensing layer 14. The conductive sensing layer 14 is disposed on the insulation layer 13, and has a line extension direction DR2. The line extension directions DR1 and DR2 are an X-axis direction and a Y-axis direction, respectively; or, the line extension directions DR1 and DR2 are a Y-axis direction and an X-axis direction, respectively. The conductive line layer 15 is disposed on the peripheral portion 112 of the substrate 11, and is electrically connected to the conductive sensing layers 12 and 14. The protective layer 16 covers the conductive sensing layer 14, the insulation layer 13 and the conductive sensing layer 12. The electrode layer 17 includes a plurality of electrodes 171, 172, 175, . . . 176, extends from the conductive line layer 15, and is in contact with the conductive sensing layers 12 and 14. The pad layer 18 is disposed on the peripheral portion 112 of the substrate 11, includes a plurality of pads 181, 182, . . . 186, and is electrically connected to the conductive line layer 15.

The conductive line layer 15 includes a plurality of conductive lines 151, 152, . . . 156. If it is desirable to fine the plurality of conductive lines 151, 152, . . . 156, a laser etching process or a lithography process of a photosensitive metallic slurry should be employed, thus achieving the fining of the plurality of conductive lines 151, 152, . . . 156.

### SUMMARY OF EXEMPLARY EMBODIMENTS

It is an aspect of the present disclosure to provide an improved method of manufacturing a plurality of conductive lines of a touch panel to fine the plurality of conductive lines.

It is therefore an embodiment of the present disclosure to provide a touch panel. The touch panel includes a substrate, a conductive sensing layer, an insulation layer and a conductive line layer. The substrate includes a central portion and a first peripheral portion. The conductive sensing layer is disposed on the central portion. The insulation layer includes a second peripheral portion, wherein the second peripheral portion has a trench structure and is disposed on the first peripheral portion. The conductive line layer is disposed in the trench structure, and is electrically connected to the conductive sensing layer.

It is therefore another embodiment of the present disclosure to provide a wiring structure. The wiring structure includes a substrate, a conductive sensing layer, an insulation layer and a wiring line layer. The conductive sensing layer is disposed on the substrate, and has a sensing line. The insulation layer includes a peripheral portion, wherein the peripheral portion has a trench structure. The wiring line layer is disposed in the trench structure, and is electrically connected to the sensing line.

It is therefore still another embodiment of the present disclosure to provide a method for forming a wiring structure. The method includes the following steps. A substrate including a central portion and a first peripheral portion is provided. A conductive sensing layer is formed on the central portion, wherein the first conductive sensing layer has a sensing line. An insulation layer is formed on the first peripheral portion, wherein the insulation layer includes a second peripheral portion. A trench structure is formed in the second peripheral portion. A wiring line layer is formed in the trench structure, wherein the wiring line layer is electrically connected to the sensing line.

### BRIEF DESCRIPTION OF THE DRAWINGS

The foregoing and other features and advantages of the present disclosure will be more clearly understood through the following descriptions with reference to the drawings, wherein:

FIG. 1A and FIG. 1B are schematic diagrams respectively showing a top view and a front view of a touch panel in the prior art;

FIG. 2A and FIG. 2B are schematic diagrams respectively showing a top view and a front view of a touch panel according to various embodiments of the present disclosure; and

FIG. 3A and FIG. 3B are schematic diagrams respectively showing a top view and a front view of a touch panel according to various embodiments of the present disclosure.

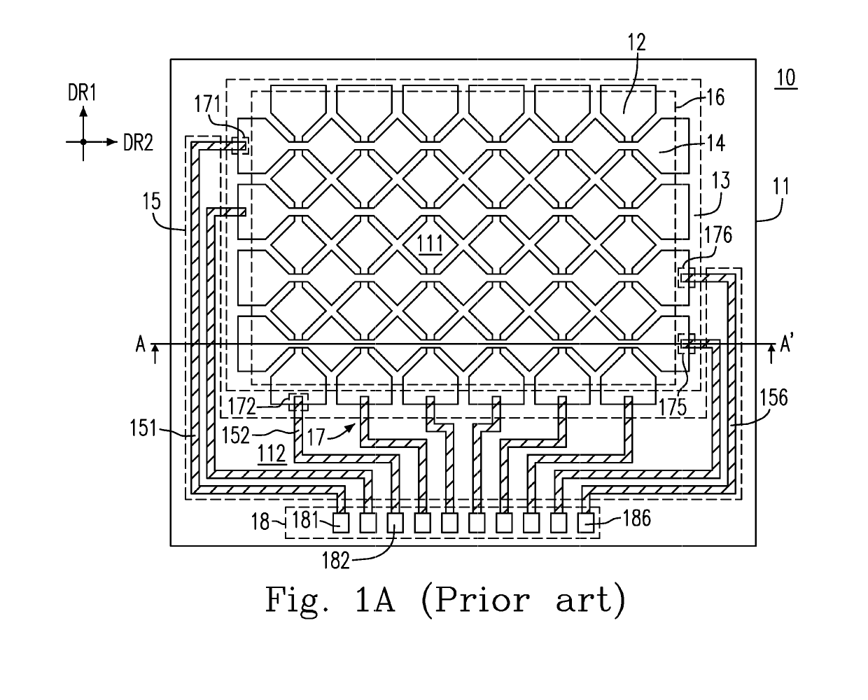

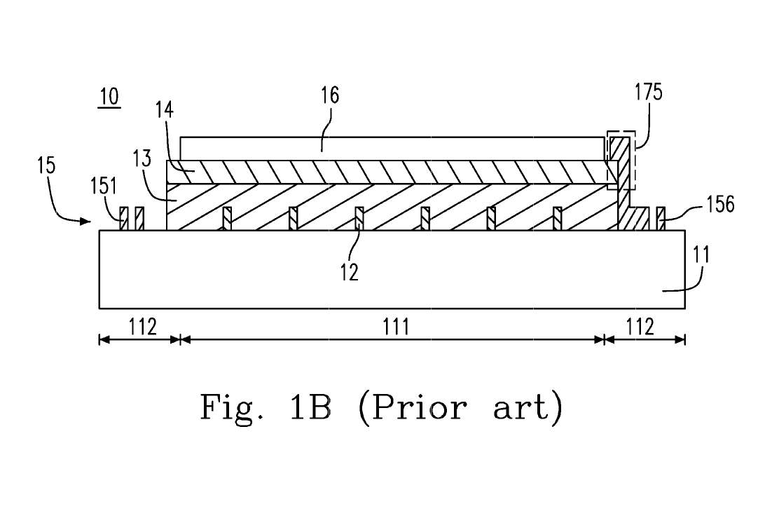

### DETAIL DESCRIPTION OF THE PREFERRED EMBODIMENTS

The present disclosure will now be described more specifically with reference to the following embodiments. It is to be noted that the following descriptions of preferred embodiments of this disclosure are presented herein for the purposes of illustration and description only; it is not intended to be exhaustive or to be limited to the precise form disclosed.

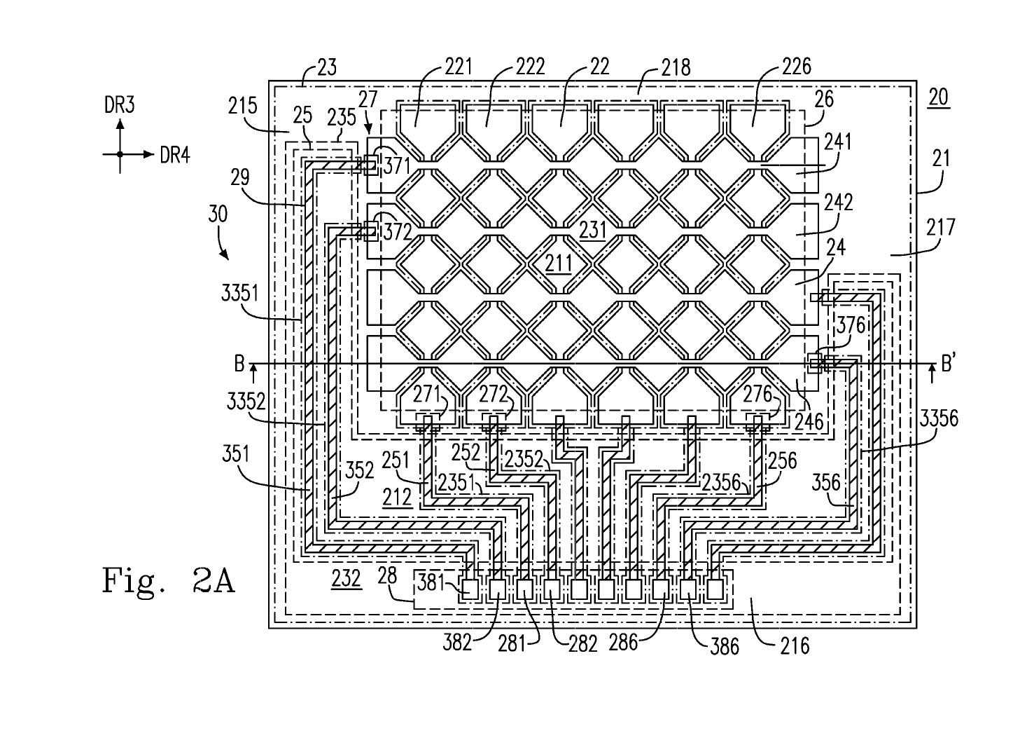

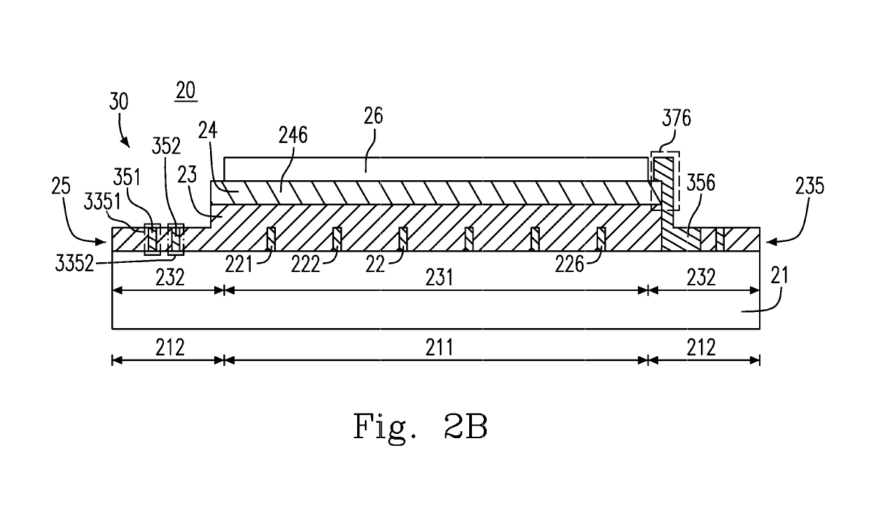

Please refer to FIG. 2A and FIG. 2B, which are schematic diagrams respectively showing a top view and a front view of a touch panel 20 according to various embodiments of the present disclosure. FIG. 2B shows a schematic front cross-sectional view at the reference line BB′ marked in FIG. 2A. The touch panel 20 includes a substrate 21, a conductive sensing layer 22, an insulation layer 23 and a conductive line layer 25. The substrate 21 includes a central portion 211 and a peripheral portion 212 associated with the central portion 211. For instance, the substrate 21 is a transparent insulation substrate, and is rigid or flexible.

In some embodiments, the substrate 21 includes the central portion 211 and four side portions 215, 216, 217 and 218 coupled to the central portion 211; and the peripheral portion 212 includes at least one selected from a group consisting of the four side portions 215, 216, 217 and 218. The side portions 217 and 218 are respectively opposite to the side portions 215 and 216; and each of the side portions 216 and 218 is adjacent to the side portions 215 and 217. For instance, the central portion 211 of the substrate 21 is used for touch sensing, and the peripheral portion 212 of the substrate 21 is used for wiring arrangement and/or decoration.

In some embodiments, the conductive sensing layer 22 is disposed on the central portion 211 of the substrate 21. The conductive sensing layer 22 includes a plurality of sensing lines 221, 222, . . . 226, and has a line extension direction DR3. The plurality of sensing lines 221, 222, . . . 226 constitute a sensing line array; and each sensing line of the plurality of sensing lines 221, 222, . . . 226 extends in the line extension direction DR3. For instance, the conductive sensing layer 22 is a transparent conductive sensing layer.

In some embodiments, the insulation layer 23 includes a central portion 231 and a peripheral portion 232 associated with the central portion 231. The central portion 231 of the insulation layer 23 is disposed on the conductive sensing layer 22; and the peripheral portion 232 of the insulation layer 23 has a trench structure 235, and is disposed on the peripheral portion 212 of the substrate 21. For instance, the insulation layer 23 is a transparent dielectric layer. In some embodiments, the insulation layer 23 has a material being a dielectric material of a resin; for instance, the resin is a photosensitive resin or a thermosetting resin. For instance, the insulation layer 23 is formed by using a lithography process or a printing process; and the printing process is a screen-printing process or a transfer-printing process. For instance, each of the trench structure 235 and the peripheral portion 232 of the insulation layer 23 is disposed on the peripheral portion 212 of the substrate 21.

In some embodiments, the conductive line layer 25 is disposed in the trench structure 235, and is electrically connected to the conductive sensing layer 22. The material of the conductive line layer 25 may be a metal, a carbon nanotube, a dried conductive slurry, an indium tin oxide (ITO) or another conductive material. The conductive line layer 25 may be manufactured by using a screen-printing process. The conductive line layer 25 may be manufactured by using a depositing process and an etching process. In some embodiments, the material of the conductive line layer 25 is a dried conductive slurry, and is formed by using a screen-printing process, wherein the conductive line layer 25 has a material including a metallic silver.

In some embodiments, the touch panel 20 further includes a conductive sensing layer 24 and a protective layer 26. The conductive sensing layer 22 is coupled to the substrate 21. The insulation layer 23 is coupled to the substrate 21 and the two conductive sensing layers 22 and 24. The protective layer 26 is coupled to the conductive sensing layer 24. The conductive line layer 25 is coupled to the substrate 21 and the two conductive sensing layers 22 and 24. The conductive sensing layer 22 is disposed between the substrate 21 and the insulation layer 23. The insulation layer 23 is disposed between the two conductive sensing layers 22 and 24.

In some embodiments, the conductive sensing layer 24 is at least partially disposed on the central portion 231 of the insulation layer 23. The conductive sensing layer 24 includes a plurality of sensing lines 241, 242, . . . 246, and has a line extension direction DR4. The plurality of sensing lines 241, 242, . . . 246 constitute a sensing line array; and each sensing line of the plurality of sensing lines 241, 242, . . . 246 extends in the line extension direction DR4. For instance, the conductive sensing layer 24 is a transparent conductive sensing layer; and the line extension direction DR4 of the conductive sensing layer 24 crosses the line extension direction DR3 of the conductive sensing layer 22. For instance, the line extension directions DR3 and DR4 are an X-axis direction and a Y-axis direction, respectively; or, the line extension directions DR3 and DR4 are a Y-axis direction and an X-axis direction, respectively.

In some embodiments, the protective layer 26 covers the conductive sensing layer 22, the central portion 231 of the insulation layer 23, and the conductive sensing layer 24. In some embodiments, the manufacturing of the protective layer 26 is an unnecessary step; and the person ordinarily skilled in the art, according to the design demand of the product, can select whether or not to manufacture the protective layer 26. For instance, the protective layer 26 is a transparent insulation protection layer.

In some embodiments, the conductive line layer 25 is further electrically connected to the conductive sensing layer 24, and includes a plurality of conductive lines 251, 252, . . . 256, and a plurality of conductive lines 351, 352, . . . 356. The plurality of conductive lines 251, 252, . . . 256 are respectively electrically connected to the plurality of sensing lines 221, 222, . . . 226; and the plurality of conductive lines 351, 352, . . . 356 are respectively electrically connected to the plurality of sensing lines 241, 242, . . . 246. In some embodiments, the trench structure 235 includes a plurality of trenches 2351, 2352, . . . 2356, and a plurality of trenches 3351, 3352, . . . 3356. The plurality of conductive lines 251, 252, . . . 256 are respectively disposed in the plurality of trenches 2351, 2352, . . . 2356; and the plurality of conductive lines 351, 352, . . . 356 are respectively disposed in the plurality of trenches 3351, 3352, . . . 3356. For instance, the plurality of trenches 2351, 2352, . . . 2356, and the plurality of trenches 3351, 3352, . . . 3356 include a specific conductive line having a width, wherein the width is in a width range from 20 μm to 30 μm.

In some embodiments, the touch panel 20 further includes an electrode layer 27 and a pad layer 28. The electrode layer 27 extends from the conductive line layer 25, and is in contact with the conductive sensing layers 22 and 24. The electrode layer 27 includes a plurality of electrodes 271, 272, . . . 276, and a plurality of electrodes 371, 372, . . . 376. In some embodiments, the pad layer 28 is electrically connected to the conductive line layer 25, and includes a plurality of pads 281, 282, . . . 286, and a plurality of pads 381, 382, . . . 386. The plurality of pads 281, 282, . . . 286 are respectively electrically connected to the plurality of conductive lines 251, 252, . . . 256, and may be respectively disposed in the plurality of trenches 2351, 2352, . . . 2356. The plurality of pads 381, 382, . . . 386 are respectively electrically connected to the plurality of conductive lines 351, 352, . . . 356, and may be respectively disposed in the plurality of trenches 3351, 3352, . . . 3356.

In some embodiments, the central portion 231 of the insulation layer 23 insulates the conductive sensing layer 22 from the conductive sensing layer 24. The central portion 231 and the peripheral portion 232 of the insulation layer 23 are made of the same material. The peripheral portion 232 of the insulation layer 23 extends or continuously extends from the central portion 231 of the insulation layer 23. The central portion 231 of the insulation layer 23 separates the central portion 211 of the substrate 21 from the conductive sensing layer 24. In some embodiments, the touch panel 20 is a capacitive touch panel. In some embodiments, the structure of the touch panel 20 in FIGS. 2A and 2B can be also applied to a resistive touch panel. In some embodiments, the peripheral portion 232 of the insulation layer 23 is separated from the central portion 231 of the insulation layer 23.

In various embodiments provided according to the illustrations in FIGS. 2A and 2B, a wiring structure 30 includes a substrate 21, a conductive sensing layer 22, an insulation layer 23 and a wiring line layer 29. The conductive sensing layer 22 is disposed on the substrate 21, and has a sensing line (such as 222). The insulation layer 23 includes a peripheral portion 232. The peripheral portion 232 of the insulation layer 23 has a trench structure 235. The wiring line layer 29 is disposed in the trench structure 235, and is electrically connected to the sensing line (such as 222) of the conductive sensing layer 22. For instance, the wiring line layer 29 is the conductive line layer 25.

In some embodiments, the wiring structure 30 serves as or is a touch panel 20, and further includes a conductive sensing layer 24 and a protective layer 26 coupled to the conductive sensing layer 24. The insulation layer 23 further includes a central portion 231 associated with the peripheral portion 232. The central portion 231 of the insulation layer 23 is disposed on the conductive sensing layer 22. The conductive sensing layer 24 is at least partially disposed on the central portion 231 of the insulation layer 23, and has a sensing line (such as 241). The protective layer 26 covers the conductive sensing layer 22, the central portion 231 of the insulation layer 23, and the conductive sensing layer 24. The wiring line layer 29 has a material including a metallic silver, and is further electrically connected to the sensing line (such as 241) of the conductive sensing layer 24.

In some embodiments, the substrate 21 includes a central portion 211 and a peripheral portion 212 associated with the central portion 211. The conductive sensing layer 22 is disposed on the central portion 211 of the substrate 21. The central portion 231 of the insulation layer 23 insulates the conductive sensing layer 22 from the conductive sensing layer 24, and separates the central portion 211 of the substrate 21 from the conductive sensing layer 24. The central portion 231 and the peripheral portion 232 of the insulation layer 23 are made of the same material. The peripheral portion 232 of the insulation layer 23 is disposed on the peripheral portion 212 of the substrate 21, and extends from the central portion 231 of the insulation layer 23.

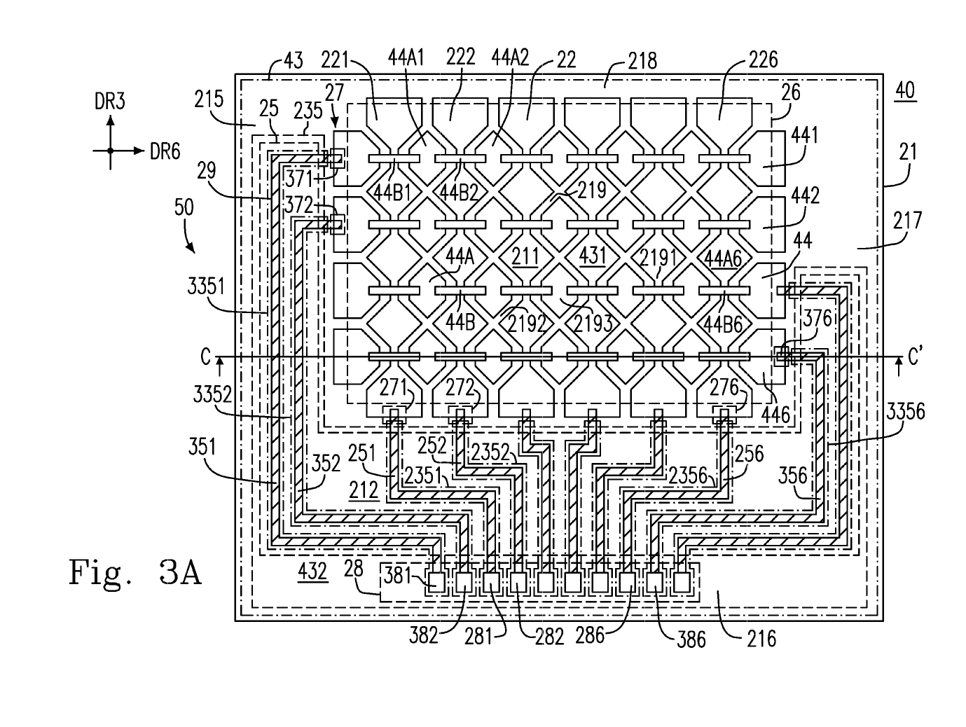

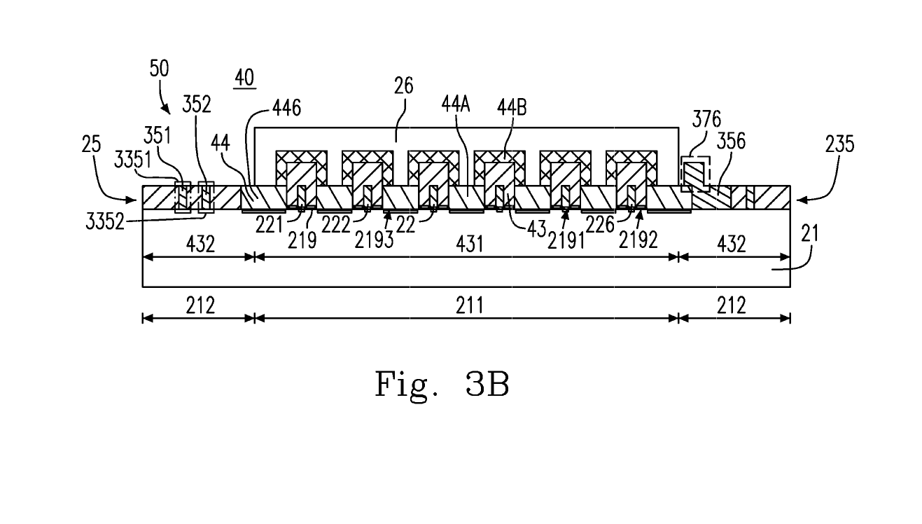

Please refer to FIG. 3A and FIG. 3B, which are schematic diagrams respectively showing a top view and a front view of a touch panel 40 according to various embodiments of the present disclosure. FIG. 3B shows a schematic front cross-sectional view at the reference line CC′ marked in FIG. 3A. The structure of the touch panel 40 is similar to that of the touch panel 20 shown in FIGS. 2A and 2B. The differences between the touch panels 40 and 20 are described as follows. In FIGS. 3A and 3B, the touch panel 40 includes a substrate 21, a conductive sensing layer 22, an insulation layer 43 and a conductive line layer 25.

In some embodiments, the insulation layer 43 includes a central portion 431 and a peripheral portion 432 associated with the central portion 431. The central portion 431 of the insulation layer 43 is disposed on the conductive sensing layer 22; and the peripheral portion 432 of the insulation layer 43 has a trench structure 235, and is disposed on the peripheral portion 212 of the substrate 21. For instance, the insulation layer 43 is a transparent dielectric layer. In some embodiments, the insulation layer 43 has a material being a dielectric material of a resin; for instance, the resin is a photosensitive resin or a thermosetting resin. For instance, the insulation layer 43 is formed by using a lithography process or a printing process; and the printing process is a screen-printing process or a transfer-printing process. The conductive line layer 25 is disposed in the trench structure 235, and is electrically connected to the conductive sensing layer 22. For instance, the touch panel 40 is a capacitive touch panel.

In some embodiments, the touch panel 40 further includes a conductive sensing layer 44 and a protective layer 26. The conductive sensing layer 44 is at least partially disposed on the central portion 431 of the insulation layer 43. The conductive sensing layer 44 includes a plurality of sensing lines 441, 442, . . . 446, and has a line extension direction DR6. The plurality of sensing lines 441, 442, . . . 446 constitute a sensing line array; and each sensing line of the plurality of sensing lines 441, 442, . . . 446 extends in the line extension direction DR6. For instance, the conductive sensing layer 44 is a transparent conductive sensing layer; and the line extension direction DR6 of the conductive sensing layer 44 crosses the line extension direction DR3 of the conductive sensing layer 22. For instance, the line extension directions DR3 and DR6 are an X-axis direction and a Y-axis direction, respectively; or, the line extension directions DR3 and DR6 are a Y-axis direction and an X-axis direction, respectively.

In some embodiments, the protective layer 26 covers the conductive sensing layer 22, the central portion 431 of the insulation layer 43, and the conductive sensing layer 44. The central portion 431 and the peripheral portion 432 of the insulation layer 43 are made of the same material. The peripheral portion 432 of the insulation layer 43 extends or continuously extends from the central portion 431 of the insulation layer 43. The conductive line layer 25 has a material including a metallic silver, and is further electrically connected to the conductive sensing layer 44.

In some embodiments, the central portion 211 of the substrate 21 includes a specific surface 219 including three surface portions 2191, 2192 and 2193. The surface portion 2192 separates the surface portion 2191 from the surface portion 2193, and is coupled to the surface portions 2191 and 2193. The conductive sensing layer 22, the central portion 431 of the insulation layer 43 and the conductive sensing layer 44 are respectively disposed on the surface portions 2191, 2192 and 2193. The conductive sensing layer 44 includes a sensing electrode portion 44A and a bridging line portion 44B coupled to the sensing electrode portion 44A. The sensing electrode portion 44A is disposed on the surface portion 2193 of the substrate 21. The bridging line portion 44B is disposed on both the sensing electrode portion 44A and the central portion 431 of the insulation layer 43. For instance, the specific surface 219 is a top surface.

In some embodiments, the sensing electrode portion 44A includes a plurality of sensing electrodes 44A1, 44A2, . . . 44A6; the bridging line portion 44B includes a plurality of bridging lines 44B1, 44B2, . . . 44B6; and a respective bridging line (such as 44B2) of the plurality of bridging lines 44B1, 44B2, . . . 44B6 forms a bridge to electrically connect two sensing electrodes (such as 44A1 and 44A2) adjacent to the respective bridging line (such as 44B2). In some embodiments, the touch panel 40 further includes an electrode layer 27 and a pad layer 28.

In some embodiments provided according to the illustrations in FIGS. 3A and 3B, the conductive sensing layer 22 includes the sensing electrode portion 44A and the plurality of sensing lines 221, 222, . . . 226; and the conductive sensing layer 44 includes the bridging line portion 44B. For instance, the conductive sensing layer 22 includes the sensing line 222, the sensing electrode 44A1 and the sensing electrode 44A2, wherein the sensing electrode 44A2 is opposite to the sensing electrode 44A1 in relation to the sensing line 222. The sensing line 222 and the central portion 431 of the insulation layer 43 are respectively disposed on the surface portions 2191 and 2192. Each of the second sensing electrodes 44A1 and 44A2 is disposed on the surface portion 2193. The conductive sensing layer 44 includes a bridging line 44B2, which extends from the sensing electrode 44A1 across the sensing line 222 to the sensing electrode 44A2, and is disposed on the central portion 431 of the insulation layer 43.

In various embodiments provided according to the illustrations in FIGS. 3A and 3B, a wiring structure 50 includes a substrate 21, a conductive sensing layer 22, an insulation layer 43 and a wiring line layer 29. The conductive sensing layer 22 is disposed on the substrate 21, and has a sensing line (such as 222). The insulation layer 43 includes a peripheral portion 432. The peripheral portion 432 of the insulation layer 43 has a trench structure 235. The wiring line layer 29 is disposed in the trench structure 235, and is electrically connected to the sensing line (such as 222) of the conductive sensing layer 22. For instance, the wiring line layer 29 is the conductive line layer 25, and is electrically connected to the sensing electrodes 44A1 and 44A2.

In some embodiments, the wiring structure 50 serves as or is a touch panel 40, and further includes a conductive sensing layer 44 and a protective layer 26. Each of the insulation layer 43, the conductive line layer 25 and the two conductive sensing layers 22 and 44 is coupled to the substrate 21. The protective layer 26 is coupled to the conductive sensing layer 44. The conductive sensing layer 22 is disposed between the substrate 21 and the insulation layer 43. The insulation layer 43 further includes a central portion 431 associated with the peripheral portion 432, is disposed between the two conductive sensing layers 22 and 44, and is coupled to the two conductive sensing layers 22 and 44. The central portion 431 of the insulation layer 43 is disposed on the conductive sensing layer 22. The conductive sensing layer 44 is at least partially disposed on the central portion 431 of the insulation layer 43, and has a sensing line (such as 441). The protective layer 26 covers the conductive sensing layer 22, the central portion 431 of the insulation layer 43, and the conductive sensing layer 44. The wiring line layer 29 has a material including a metallic silver, and is further electrically connected to the sensing line (such as 441) of the conductive sensing layer 44.

In various embodiments provided according to the illustrations in FIGS. 2A, 2B, 3A and 3B, a method for forming a wiring structure 30 or 50 includes the following steps. A substrate 21 is provided, wherein the substrate 21 includes a central portion 211 and a peripheral portion 212 associated with the central portion 211. A conductive sensing layer 22 is formed on the central portion 211 of the substrate 21, wherein the conductive sensing layer 22 has a sensing line (such as 222). An insulation layer 23 (or 43) is formed on the peripheral portion 212 of the substrate 21, wherein the insulation layer 23 (or 43) includes a peripheral portion 232 (or 432). A trench structure 235 is formed in the peripheral portion 232 (or 432) of the insulation layer 23 (or 43). A wiring line layer 29 is formed in the trench structure 235, wherein the wiring line layer 29 is electrically connected to the sensing line (such as 222) of the conductive sensing layer 22.

In some embodiments, the insulation layer 23 (or 43) further forms a central portion 231 (or 431) associated with the peripheral portion 232 (or 432), wherein the central portion 231 (or 431) of the insulation layer 23 (or 43) is at least partially disposed on the conductive sensing layer 22. The method further includes the following steps. A conductive sensing layer 24 or 44 is at least partially formed on the central portion 231 of the insulation layer 23, wherein the conductive sensing layer 24 (or 44) includes a sensing line (such as 241 (or 441)), and the wiring line layer 29 is further electrically connected to the sensing line (such as 241 (or 441)) of the conductive sensing layer 24 (or 44). A protective layer 26 is formed to cover the conductive sensing layer 22, the central portion 231 (or 431) of the insulation layer 23 (43), and the conductive sensing layer 24 (or 44).

In some embodiments, the step of forming the wiring line layer 29 in the trench structure 235 includes the following sub-steps. The trench structure 235 is filled with a conductive slurry by using a screen printing process, wherein the conductive slurry includes a metallic silver. The conductive slurry is dried to form a dried conductive slurry. A portion of the dried conductive slurry is removed to form the wiring line layer 29.

In some embodiments, the wiring structure 30 (or 50) serves as a touch panel 20 (or 40). The portion of the dried conductive slurry is removed by using a polishing process, wherein the polishing process is stopped by using the peripheral portion 232 (or 432) of the insulation layer 23 (or 43). The central portion 231 (or 431) of the insulation layer 23 (or 43) and the trench structure 235 are formed simultaneously. In some embodiments, the ingredients of the conductive slurry include a metallic powder, a low-melting-point glass powder and a binding agent, wherein the metallic powder is preferably a silver powder, and the binding agent is preferably a terpineol or an ethyl cellulose.

In some embodiments, the central portion 211 of the substrate 21 includes a specific surface 219 including three surface portions 2191, 2192 and 2193. The surface portion 2192 separates the surface portion 2191 from the surface portion 2193, and is coupled to the surface portions 2191 and 2193. The conductive sensing layer 22 and the central portion 431 of the insulation layer 43 are respectively formed on the surface portions 2191 and 2192. The step of forming the conductive sensing layer 44 on the central portion 431 of the insulation layer 43 includes the following sub-steps. A sensing electrode portion 44A is formed on the surface portion 2193 of the substrate 21. A bridging line portion 44B is formed on both the sensing electrode portion 44A and the central portion 431 of the insulation layer 43.

In some embodiments, the conductive sensing layer 22 further includes the sensing electrode 44A1 and the sensing electrode 44A2, wherein the sensing electrode 44A2 is opposite to the sensing electrode 44A1 in relation to the sensing line 222. The sensing line 222 and the central portion 431 of the insulation layer 43 are respectively disposed on the surface portions 2191 and 2192. Each of the sensing electrodes 44A1 and 44A2 is disposed on the surface portion 2193. The method includes a step of forming a conductive sensing layer 44 on the central portion 431 of the insulation layer 43. The step of forming the conductive sensing layer 44 on the central portion 431 of the insulation layer 43 includes a sub-step of forming a bridging line 44B2 on the central portion 431 of the insulation layer 43, wherein the bridging line 44B2 extends from the sensing electrode 44A1 across the sensing line 222 to the sensing electrode 44A2.

In the prior art, a plurality of conductive lines 151, 152, . . . 156 (such as a plurality of silver lines) are arranged in the peripheral area of the sensor of the touch panel 10, wherein the sensor includes the conductive sensing layer 12, the insulation layer 13 and the conductive sensing layer 14. If it is desirable to fine the plurality of conductive lines 151, 152, . . . 156, a laser etching process or a lithography process of a photosensitive metallic slurry should be employed, thus achieving the fining of the plurality of conductive lines 151, 152, . . . 156. In some embodiments of the present disclosure, when the dielectric insulation layer (such as the insulation layer 23) to be disposed between the X-line and the Y-line layers (such as the conductive sensing layers 22 and 24) is formed, a plurality of peripheral line trenches (such as the plurality of trenches 2351, 2352, . . . 2356, and the plurality of trenches 3351, 3352, . . . 3356) is manufactured simultaneously; and then the plurality of trenches are filled with a silver slurry by using a silver-slurry screen-printing technique, thus achieving the fining of the plurality of silver wiring lines.

In some embodiments of the present disclosure, the plurality of trenches are filled with the silver slurry; the silver slurry is dried to form a dried silver slurry; a surface treatment (such as a polishing treatment) is performed to the dried silver slurry to remove the surplus dried silver slurry, so that only the remaining dried silver slurry forms in the plurality of trenches. The remaining dried silver slurry forms the plurality of conductive lines 251, 252, . . . 256 and the plurality of trenches 351, 352, . . . 356 to achieve the fining of the plurality of silver lines.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A touch panel, comprising:
a substrate including a first central portion and a first peripheral portion;
a first conductive sensing layer disposed on the first central portion;
an insulation layer including a second peripheral portion, wherein the second peripheral portion has a trench structure and is disposed on the first peripheral portion; and
a conductive line layer disposed in the trench structure, and electrically connected to the first conductive sensing layer.

2. The touch panel according to claim 1, wherein the insulation layer further includes a second central portion disposed on the first conductive sensing layer.

3. The touch panel according to claim 2, wherein the second central portion and the second peripheral portion are made of the same material.

4. The touch panel according to claim 2, further comprising:
a second conductive sensing layer at least partially disposed on the second central portion; and
a protective layer covering the first conductive sensing layer, the second central portion, and the second conductive sensing layer.

5. The touch panel according to claim 4, wherein:
the second central portion insulates the first conductive sensing layer from the second conductive sensing layer; and
the conductive line layer has a material including a metallic silver, and is further electrically connected to the second conductive sensing layer.

6. The touch panel according to claim 4, wherein the second central portion separates the first central portion from the second conductive sensing layer.

7. The touch panel according to claim 4, wherein:
the first central portion includes a specific surface, wherein the specific surface includes a first surface portion, a second surface portion and a third surface portion, and the second surface portion separates the first surface portion from the third surface portion; and
the first conductive sensing layer, the second central portion and the second conductive sensing layer are respectively disposed on the first, the second and the third surface portions

8. The touch panel according to claim 7, wherein the second conductive sensing layer comprises:
a sensing electrode portion disposed on the third surface portion; and
a bridging line portion disposed on both the sensing electrode portion and the second central portion.

9. The touch panel according to claim 4, wherein:
the first conductive sensing layer includes a sensing line, a first sensing electrode and a second sensing electrode opposite to the first sensing electrode in relation to the sensing line;
the first central portion includes a specific surface, wherein the specific surface includes a first surface portion, a second surface portion and a third surface portion, and the second surface portion separates the first surface portion from the third surface portion;
the sensing line and the second central portion are respectively disposed on the first and the second surface portions;
each of the first and the second sensing electrodes is disposed on the third surface portion; and
the second conductive sensing layer includes:
a bridging line extending from the first sensing electrode across the sensing line to the second sensing electrode, and disposed on the second central portion.

10. A wiring structure, comprising:
a substrate;
a first conductive sensing layer disposed on the substrate, and having a first sensing line;
an insulation layer including a first peripheral portion, wherein the first peripheral portion has a trench structure; and
a wiring line layer disposed in the trench structure, and electrically connected to the first sensing line.

11. The wiring structure according to claim 10, wherein the insulation layer further includes a first central portion disposed on the first conductive sensing layer

12. The wiring structure according to claim 11, wherein the first central portion and the first peripheral portion are made of the same material.

13. The wiring structure according to claim 11, serving as a touch panel, and further comprising:
a second conductive sensing layer at least partially disposed on the first central portion, and having a second sensing line; and
a protective layer covering the first conductive sensing layer, the first central portion, and the second conductive sensing layer.

14. The wiring structure according to claim 13, wherein:
the substrate includes a second central portion and a second peripheral portion;
the first conductive sensing layer is disposed on the second central portion;
the first central portion insulates the first conductive sensing layer from the second conductive sensing layer;
the first peripheral portion is disposed on the second peripheral portion; and
the wiring line layer has a material including a metallic silver, and is further electrically connected to the second sensing line.

15. The wiring structure according to claim 14, wherein the first central portion separates the second central portion from the second conductive sensing layer.

16. The wiring structure according to claim 14, wherein:
the second central portion includes a specific surface, wherein the specific surface includes a first surface portion, a second surface portion and a third surface portion, and the second surface portion separates the first surface portion from the third surface portion; and
the first conductive sensing layer, the first central portion and the second conductive sensing layer are respectively disposed on the first, the second and the third surface portions.

17. The wiring structure according to claim 16, wherein the second conductive sensing layer comprises:
a sensing electrode portion disposed on the third surface portion; and
a bridging line portion disposed on both the sensing electrode portion and the first central portion.

18. The wiring structure according to claim 11, serving as a touch panel, and further comprising:
a second conductive sensing layer at least partially disposed on the first central portion, wherein:
the substrate includes a second central portion and a second peripheral portion;
the first conductive sensing layer is disposed on the second central portion, and further has a first sensing electrode and a second sensing electrode opposite to the first sensing electrode in relation to the first sensing line;
the first peripheral portion is disposed on the second peripheral portion;
the wiring line layer is further electrically connected to at least one of the first and the second sensing electrodes;
the second central portion includes a specific surface, wherein the specific surface includes a first surface portion, a second surface portion and a third surface portion, and the second surface portion separates the first surface portion from the third surface portion;
the first sensing line and the first central portion are respectively disposed on the first and the second surface portions;
each of the first and the second sensing electrodes is disposed on the third surface portion; and
the second conductive sensing layer includes a bridging line, wherein the bridging line extends from the first sensing electrode across the first sensing line to the second sensing electrode, and is disposed on the first central portion.

19. A method for forming a wiring structure, comprising steps of:
providing a substrate including a first central portion and a first peripheral portion;
forming a first conductive sensing layer on the first central portion, wherein the first conductive sensing layer has a first sensing line;
forming an insulation layer on the first peripheral portion, wherein the insulation layer includes a second peripheral portion;
forming a trench structure in the second peripheral portion; and
forming a wiring line layer in the trench structure, wherein the wiring line layer is electrically connected to the first sensing line.

20. The method according to claim 19, wherein the insulation layer further forms a second central portion at least partially disposed on the first sensing line, and the method further comprises steps of:
forming a second conductive sensing layer on the second central portion; and
forming a protective layer to cover the first conductive sensing layer, the second central portion, and the second conductive sensing layer.

21. The method according to claim 20, wherein:
the second conductive sensing layer includes a second sensing line electrically connected to the wiring line layer;
the first central portion includes a specific surface, wherein the specific surface includes a first surface portion, a second surface portion and a third surface portion, and the second surface portion separates the first surface portion from the third surface portion;
the first conductive sensing layer and the second central portion are respectively disposed on the first and the second surface portions; and
the step of forming the second conductive sensing layer on the second central portion comprises sub-steps of:
forming a sensing electrode portion on the third surface portion; and
forming a bridging line portion on both the sensing electrode portion and the second central portion.

22. The method according to claim 21, wherein:
the wiring structure serves as a touch panel; and
the second central portion and the trench structure are formed simultaneously.

23. The method according to claim 19, wherein the step of forming the wiring line layer in the trench structure comprises sub-steps of:
filling the trench structure with a conductive slurry by a screen printing process;
drying the conductive slurry to form a dried conductive slurry; and
removing a portion of the dried conductive slurry to form the wiring line layer.

24. The method according to claim 23, wherein the conductive slurry includes a metallic silver.

25. The method according to claim 23, wherein the portion of the dried conductive slurry is removed by using a polishing process.

26. The method according to claim 19, wherein the insulation layer further forms a second central portion at least partially disposed on the first conductive sensing layer, and the method further comprises a step of:
forming a second conductive sensing layer on the second central portion, wherein:
the first conductive sensing layer further includes a first sensing electrode and a second sensing electrode opposite to the first sensing electrode in relation to the first sensing line;
the wiring line layer is further electrically connected to at least one of the first and the second sensing electrodes;
the first central portion includes a specific surface, wherein the specific surface includes a first surface portion, a second surface portion and a third surface portion, and the second surface portion separates the first surface portion from the third surface portion;
the first sensing line and the second central portion are respectively disposed on the first and the second surface portions;
each of the first and the second sensing electrodes is disposed on the third surface portion; and
the step of forming the second conductive sensing layer on the second central portion comprises a sub-step of forming a bridging line on the second central portion, wherein the bridging line extends from the first sensing electrode across the sensing line to the second sensing electrode.
